(19) United States
(12) Patent Application Publication
(10) Pub. No.: US 2026/0326392 A1
(43) Pub. Date: Oct. 22, 2026

(54) INTRAVENOUS FLUID CONTAINER MANUFACTURING APPARATUS

(71) Applicants: JW HOLDINGS CORPORATION, Gyeonggi-do (KR); SHINJIN Mtec CO., LTD., Gyenggi-do (KR)

(72) Inventors: Du Hyun KANG, Gyeonggi-do (KR); Sang Young LEE, Chungcheongnam-do (KR); Gi Cheol JANG, Gyeonggi-do (KR); Cheol Ho BAEK, Gyeonggi -do (KR)

(21) Appl. No.: 19/117,550

(22) PCT Filed: Oct. 4, 2023
(86) PCT No.: PCT/KR2023/015249

§ 371 Date: Apr. 1, 2025

(30) Foreign Application Priority Data
Oct. 5, 2022 (KR) 10-2022-0126986
Oct. 4, 2023 (KR) 10-2023-0131590

(51) Int. Cl. B29C 65/78; A61J 1/10; B29C 65/02; B29L 31/00

(52) U.S. Cl. CPC B29C 65/7841; A61J 1/10; B29C 65/02; B29C 65/787; B29L 2031/7148

(57) ABSTRACT

An intravenous fluid container manufacturing apparatus comprises a conveyance unit comprising: a first gripper unit that supplies the intravenous fluid container to a bag outer sealing part; and a second gripper unit that supplies the intravenous fluid container to a hard port body sealing part. When an outer sealing mold of the bag outer sealing part contacts the intravenous fluid container, the second gripper unit enters the bag outer sealing part and grips an edge of the intravenous fluid container at a first point, and when the outer sealing mold of the bag outer sealing part is separated from the intravenous fluid container, the second gripper unit, together with the first gripper unit of the bag outer sealing part, conveys the intravenous fluid container to the hard port body until a second point is reached while holding the edge of the intravenous fluid container.

### TECHNICAL FIELD

The present invention relates to an intravenous fluid container manufacturing apparatus.

### BACKGROUND ART

An intravenous fluid container includes a body and a port disposed on the body. The body may be made of a flexible material. The interior of the body is filled with intravenous fluid. The intravenous fluid is either introduced into the body through the port or discharged to the outside through the port.

An intravenous fluid container manufacturing apparatus may be broadly classified into an apparatus that forms a body by sealing overlapping sheets and an apparatus that attaches and seals a port to the formed body.

Korean Patent No. 10-2022070 (published on Sep. 18, 2019, hereinafter referred to as “this document”) discloses an apparatus for manufacturing an intravenous fluid container. In this document, a configuration is disclosed in which two sheets, each wound on a take-up roll, are overlapped, and the outer edges of the sheets are sealed to form a body.

The intravenous fluid container manufacturing apparatus is capable of performing both the process of manufacturing an intravenous fluid container that contains medicinal fluid and the process of filling the manufactured intravenous fluid container with medicinal fluid.

In the process of manufacturing an intravenous fluid container, the process may proceed while a set consisting of a plurality of intravenous fluid containers is transported by a transport unit. For example, in order to transport a film sheet to a bag outer sealing part, which forms the outer contour of the intravenous fluid container, the transport unit pulls only one side of the film sheet and supplies it to the bag outer sealing part.

However, such a transport unit has the issue that the film sheet may become misaligned toward one side. Additionally, the transport unit may use a vacuum suction pad to transfer the film sheet from the bag outer sealing part to the next process. However, when the transport unit carries the film sheet, a problem occurs in which the film sheet, which has been softened due to heating in the bag outer sealing part, sags due to its own weight or gets caught on a mold or the like located below during transport, causing it to wrinkle. Furthermore, since the transport unit requires a suction process for the film sheet, it results in a slower production speed. When vacuum suction is applied to the heated and softened film sheet, thermal deformation may occur due to the vacuum suction. To avoid such thermal deformation, the positioning of the vacuum suction pad becomes highly restricted, posing another issue.

### DETAILED DESCRIPTION OF THE INVENTION

### Technical problem

An objective of the present invention is to provide an intravenous fluid container manufacturing apparatus capable of preventing a film sheet of an intravenous fluid container from becoming misaligned to one side or sagging during transport, while also increasing the production speed.

The objectives to be achieved by the present invention are not limited to the foregoing objective, and additional objectives, which are not mentioned herein, will be readily understood by those skilled in the art from the following description.

### Technical Solution

One embodiment provides an intravenous fluid container manufacturing apparatus including a conveyance unit for conveying an intravenous fluid container, wherein the conveyance unit includes a first gripper unit configured to supply the intravenous fluid container to a bag outer sealing part, and a second gripper unit configured to supply the intravenous fluid container to a hard port body sealing part, wherein, when an outer sealing mold of the bag outer sealing part contacts the intravenous fluid container, the second gripper unit enters the bag outer sealing part and grips an edge of the intravenous fluid container at a first point, and when the outer sealing mold of the bag outer sealing part is separated from the intravenous fluid container, the second gripper unit, together with the first gripper unit of the bag outer sealing part, conveys the intravenous fluid container to the hard port body until a second point is reached while holding the edge of the intravenous fluid container.

The second gripper unit may move from an outlet of the bag outer sealing part to an outlet of the hard port body sealing part. The first gripper unit and the second gripper unit may move together simultaneously.

A plurality of intravenous fluid containers may form one set, a belt may be included for transporting the intravenous fluid containers in set units, and when the belt transports the intravenous fluid containers by one set, the first gripper unit and the second gripper unit may simultaneously move by a distance corresponding to one set.

When the mold of the bag outer sealing part comes into contact with the intravenous fluid container, the first gripper unit may move backward from the first point, and the second gripper unit may move to the first point and grips the intravenous fluid container.

The first point may correspond to a position of the intravenous fluid container that is located at the foremost position among a set of intravenous fluid containers in the bag outer sealing part. The second point may correspond to a position of the intravenous fluid container that is located at the foremost position among the set of intravenous fluid containers in the hard port body sealing part.

The first gripper unit may include a left gripper unit and a right gripper unit, and the left gripper unit and the right gripper unit may be arranged to face each other.

The left gripper unit may grip one side of the intravenous fluid container, and the right gripper unit may grip the other side of the intravenous fluid container, thereby supplying the intravenous fluid container to the bag outer sealing part.

The first gripper unit and the second gripper unit may each grab a scrap of the intravenous fluid container and move.

### Advantageous Effects

According to the embodiment, there is an advantage in that a film sheet of an intravenous fluid container can be stably supplied to a bag outer sealing part without becoming misaligned to one side.

According to the embodiment, since the outer edge of the film sheet is fixed by a gripper and supplied to a hard port body sealing part, sagging of the film sheet of the intravenous fluid container can be prevented.

According to the embodiment, while sealing is performed in the bag outer sealing part, a first gripper unit and a second gripper unit grip the film sheet and return to the starting point, and they fix and hold the film sheet in advance before the mold of the bag outer sealing part opens. Once the mold of the bag outer sealing part fully opens, the film sheet is transported to the hard port body sealing part. As a result, the operations required when transporting the film sheet using the conventional vacuum suction method, where a vacuum suction pad enters the mold of the bag outer sealing part after the mold opens, then descends, performs suction, ascends, and subsequently transports the film sheet to the hard port body sealing unit, are eliminated. This shortens the production cycle time of the intravenous fluid container by more than one second and provides the advantage of increasing the production speed from the conventional 3,500 BPH to 4,000 BPH to 4,200 BPH.

In addition, according to the embodiment, the second gripper unit is designed to grip and transport the film sheet by holding the scrap portion that is discarded after cutting the film sheet on which outer sealing has been performed, thereby eliminating the problem of deformation of the suction portion of the film sheet that occurs when a heated film sheet is held by a vacuum suction pad.

### BRIEF DESCRIPTION OF DRAWINGS

FIG. 1 is a diagram illustrating an intravenous fluid container manufacturing apparatus according to an embodiment;

FIG. 2 is a diagram illustrating a first gripper unit arranged in a bag outer sealing part and a second gripper unit arranged in a hard port body sealing part;

FIG. 3 is a diagram illustrating the first gripper unit;

FIG. 4 is a diagram illustrating the second gripper unit;

FIG. 5 is a diagram illustrating an intravenous fluid container being gripped by a first gripper unit;

FIGS. 6, 7, 8 and 9 are diagrams illustrating the operation process of a first gripper unit and a second gripper unit; and

FIG. 10 is a diagram illustrating the grip positions of the first gripper unit and the second gripper unit.

### MODE FOR INVENTION

The objects, features and advantages of the present invention will be more clearly understood from the following detailed description and preferred embodiments taken in conjunction with the accompanying drawings. In addition, terms and words used in this specification and the appended claims should not be interpreted as those defined in commonly used dictionaries. Accordingly, the terms and words should be interpreted on the basis of the meaning and concept in accordance with the technical spirit of the present invention according to the principle that the inventor can properly define the concept of terms so as to best describe the present invention. Moreover, descriptions and details of well-known features and techniques may be omitted to avoid unnecessarily obscuring the discussion of the described embodiments of the invention.

Hereinafter, an intravenous fluid container manufacturing apparatus according to an embodiment will be described in detail with reference to the accompanying drawings. In the drawings below, the x-axis corresponds to the left-right direction of the intravenous fluid container manufacturing apparatus, which is the transport direction of an intravenous fluid container. The y-axis corresponds to the front-rear direction of the intravenous fluid container manufacturing apparatus. The z-axis corresponds to the vertical (up-down) direction of the intravenous fluid container manufacturing apparatus.

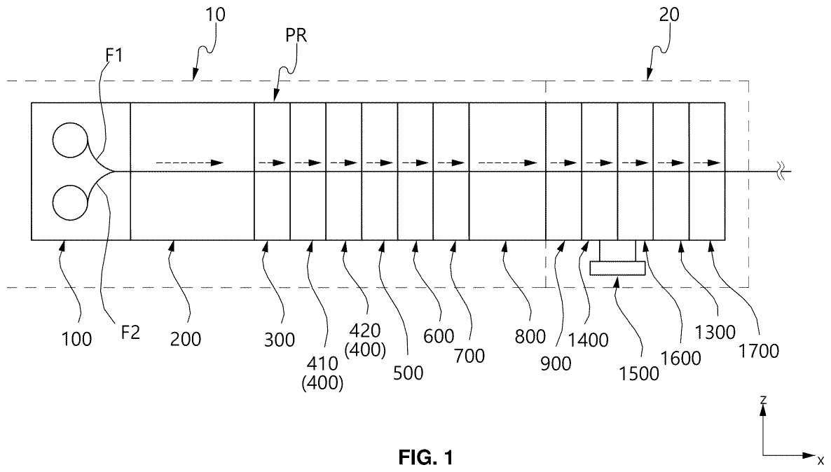

FIG. 1 is a diagram illustrating an intravenous fluid container manufacturing apparatus according to an embodiment.

Referring to FIG. 1, the entire process of the intravenous fluid container manufacturing apparatus will be described. The intravenous fluid container manufacturing apparatus may include an intravenous fluid container manufacturing unit 10 and a filling unit 20.

The intravenous fluid container manufacturing unit 10 may include an unwinding part 100, a printing part 200, a bag outer sealing part 300, a hard port body primary and secondary preheating unit PR, a hard port body sealing part 400, a primary scrap removal part 500, a secondary scrap removal and bag separation part 600, an inspection part 700, and a bag transfer 800.

A film sheet is supplied through the unwinding part 100. The unwinding part 100 supplies sheets F1 and F2, which are materials for an intravenous fluid container 1. The first sheet F1 is supplied while the first sheet F1 and the second sheet F2 are respectively wound on reels, and when the first sheet F1 is exhausted, the end of the first sheet F1 is cut, and the end of the second sheet F2 is joined to the cut end of the first sheet F1, so that the second sheet F2 continues to be supplied. The exhausted first sheet F1 is replaced with a new sheet. This is to ensure the continuity of the operation of the entire apparatus without stopping when the sheet is replaced after being used up.

The first sheet F1 and the second sheet F2 are each formed as double layers, and in the process of the first sheet F1 or the second sheet F2 being fed into the bag outer sealing part 300, a knife (not shown) is inserted between the two layers of the sheet to spread them apart, so that a hard port body 1a, which will be described further below, can be inserted between the two layers. The sheets are thus spread and supplied to the bag outer sealing part 300.

Hereinafter, the processes applied to the first sheet F1 are equally applicable to the second sheet F2, which is continuously fed after being joined to the end of the first sheet F1.

The printing part 200 prints characters or designs on the surface of the first sheet F1 or the second sheet F2. In addition, the printing part 200 may be supplied with printing ribbons of different colors so that characters or designs can be printed in two colors.

The bag outer sealing part 300 heat-seals the edges of the double-layered first sheet F1 or second sheet F2 corresponding to the periphery of the intravenous fluid container 1, thereby forming the body of the intravenous fluid container 1 in which intravenous fluid is contained. The bag outer sealing part 300 may include a mold (not shown) that pressurizes the first sheet F1 or the second sheet F2, and a knife (not shown) that cuts the first sheet F1 or the second sheet F2. Before the first sheet F1 or the second sheet F2 enters the bag outer sealing part 300, the area of the first sheet F1 or the second sheet F2 where the hard port body 1a is to be inserted is spread apart, and the hard port body 1a is inserted. Then, in the bag outer sealing part 300, the sheet is temporarily fixed by tack sealing, and subsequently, the edge of the first sheet F1 or the second sheet F2 is heat-sealed to form the intravenous fluid container 1.

The first sheet F1 or the second sheet F2 may be cut in such a way that a plurality of intravenous fluid containers 1 are transported as units from the bag outer sealing part 300. For example, the cutting may be performed so that four intravenous fluid containers 1 form one set and are transported together.

The hard port body primary and secondary preheating unit PR performs primary and secondary preheating. In the hard port body primary and secondary preheating unit PR, a gripper cylinder (not shown) equipped with a heated electric heater mold moves up and down to press and heat the sealing area between the hard port body 1a and the first sheet F1 or the second sheet F2 to a temperature of approximately 130 °C, thereby making the hard surface of the hard port body 1a pliable.

The mold shape of the hard port body primary and secondary preheating unit PR is designed to match the shape of the hard port body 1a, ensuring that heat is evenly transferred to the surface of the hard port body 1a. The mold of the hard port body primary and secondary preheating unit PR is designed to allow adjustment of the vertical gap and horizontal position.

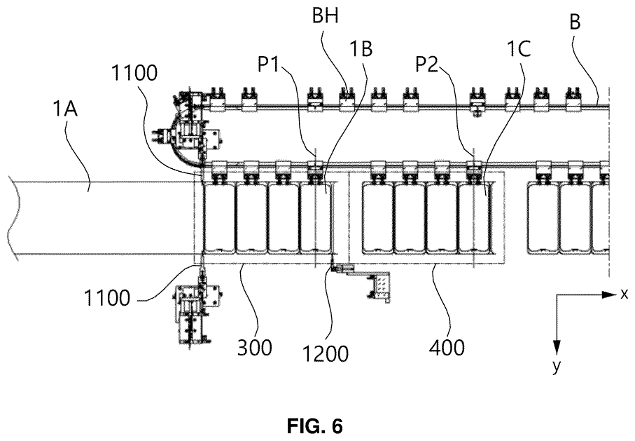

Once the primary heating of the hard port body 1a is completed, the gripper cylinder (not shown) of the hard port body primary and secondary preheating unit PR opens and returns to its original position. Then, a main belt head (BH in FIG. 6) moves the hard port bodies forward in sets of four by one pitch to the next process, which is the secondary preheating step. The number of hard port bodies transported as one set may vary depending on the design, and one pitch refers to the distance that one set of hard port bodies moves.

Next, secondary preheating is performed. For example, the area that underwent the primary preheating is heated for a certain period of time at a temperature of approximately 150 °C to further soften the surface of the hard port body 1a. The process is divided into primary preheating and secondary heating, and the temperature is varied from a low temperature to a high temperature. This is to gradually increase the temperature so that the hard port body 1a is not damaged by high heat, while also allowing sufficient time for heating the hard port body 1a.

The primary and secondary preheating processes are positioned close to the bag outer sealing process, so that after the secondary preheating, the main belt (B in FIG. 6) rotates and the hard port body 1a is immediately moved into the mold of the bag outer sealing part 300, thereby preventing the heated hard port body from cooling during transport.

The hard port body sealing part 400 heat-seals the area around the hard port body 1a, thereby fixing the hard port body 1a to the intravenous fluid container 1. The hard port body sealing part 400 may include a mold that corresponds to the shape of the hard port body 1a. A plurality of such molds may be arranged. A plurality of molds that apply pressure to different areas of the hard port body 1a may be positioned, and multiple heat-sealing steps may be performed.

The primary scrap removal part 500 and the secondary scrap removal and bag separation part 600 simultaneously grip and remove the scraps located at the top and bottom ends of the intravenous fluid container 1, and cut a set of intravenous fluid containers 1 into individual intravenous fluid containers.

In the primary scrap removal part 500, when the sheet is transported, the clamp cylinder descends to fix the sheet and the gripper grips the scrap, cut into a round shape, in a hanger portion between the bags and pulls it downward to remove the scrap and discard it into a collection bin. After that, the clamp ascends. The hanger portion refers to the part located opposite the area where the hard port of the intravenous fluid container is formed.

When the process is completed in the primary scrap removal part 500, the main belt B rotates and moves the four bags by one pitch and guides them to the secondary scrap removal and bag separation part 600.

In the secondary scrap removal and bag separation part 600, when the sheet is transported, a fixed clamp descends, and the gripper cylinder (not shown) holding the film sheet grips and lifts the scrap cut in a rounded shape on the side of the sheet, thereby removing it. Then, when a gripper (not shown) moves in the hanger direction, a separation knife located behind the gripper separates the bags.

The secondary scrap removal and bag separation part 600 removes the scrap from the portion where the hard port body of the intravenous fluid container is formed and performs the operation of separating the bags of the intravenous fluid containers from each other.

The inspection part 700 determines whether the intravenous fluid container 1 can be vacuum-sealed.

When the sheet from which the scrap has been removed is transported to the inspection part 700, a clamp descends to fix the sheet, and a nozzle is inserted into the inlet of the hard port body 1a to seal the hard port body. Then, when vacuum is applied through the nozzle and the measured vacuum value reaches a set value, the nozzle moves backward and is separated. If the hard port body is sealed to the outside of the sheet and a vacuum cannot be formed, which indicates a defective bag, the defective bag is dropped into a defective-product discharge bin. The bag transfer 800 fixes the hard port body to a filling process head.

The filling part 20 may include cap press-fitting parts 900 and 1300, a primary filling part 1400, a secondary filling part 1600, a medicinal fluid supply part 1500, and a non-defective product discharge part 1700.

The cap press-fitting parts 900 and 1300 press-fit a cap into the hard port body 1a of the intravenous fluid container 1. A cap is press-fitted into each of the two hard port bodies 1a formed on a single intravenous fluid container 1. First, one of the two caps may be press-fitted into the hard port body 1a of the intravenous fluid container 1.

The primary filling part 1400 may fill medicinal fluid into the intravenous fluid container 1 into which a cap has been press-fitted.

The secondary filling part 1600 may additionally fill medicinal fluid into the intravenous fluid container 1 that has been filled by the primary filling part 1400.

After the filling of medicinal fluid is completed in the secondary filling part 1600, the cap press-fitting parts 900 and 1300 may press-fit the remaining one of the two caps into the other hard port body 1a of the intravenous fluid container 1.

The medicinal fluid supply unit 1500 is connected to the primary filling part 1400 and the secondary filling part 1600, and supplies medicinal fluid to each of the primary filling part 1400 and the secondary filling part 1600. A non-defective product for which the filling of medicinal fluid has been completed is discharged through the non-defective product discharge part 1700.

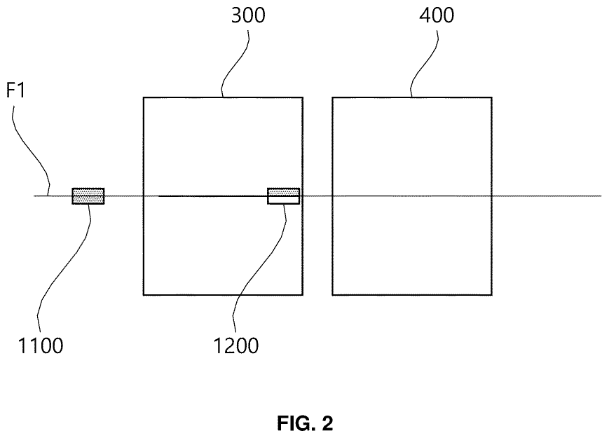

FIG. 2 is a diagram illustrating a first gripper unit 1100 arranged in the bag outer sealing part 300 and a second gripper unit 1200 arranged in the hard port body sealing part 400.

Referring to FIG. 2, the bag outer sealing part 300 seals the outer edge of the double-layered first sheet F1 or second sheet F2 fed from the printing part 200, thereby forming the outer contour of the intravenous fluid container 1. A cutter is arranged between molds (not shown) of the bag outer sealing part 300, allowing the formed intravenous fluid containers 1 to be separated in a set unit. Each set may consist of four intravenous fluid containers 1, or a greater or lesser number.

The first gripper unit 1100 grips and supplies the intravenous fluid container 1 to the bag outer sealing part 300.

The second gripper unit 1200 is arranged next to the first gripper unit 1100. The second gripper unit 1200 grips and supplies the intravenous fluid container 1, which has completed outer sealing in the bag outer sealing part 300, to the hard port body sealing part 400.

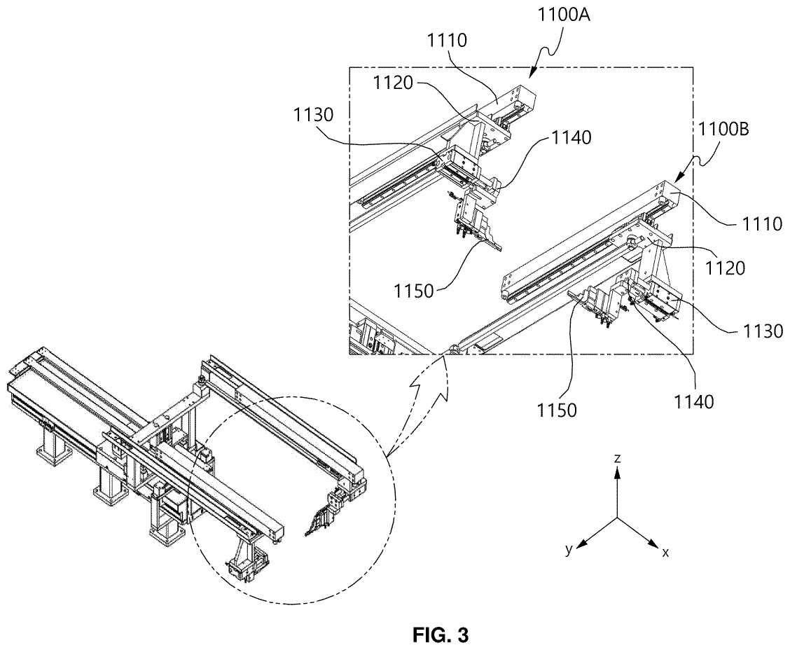

FIG. 3 is a diagram illustrating the first gripper unit 1100.

Referring to FIG. 3, the first gripper unit 1100 may include a left gripper unit 1100A and a right gripper unit 1100B. The left gripper unit 1100A and the right gripper unit 1100B are arranged to face each other. Referring to FIG. 6, the left gripper unit 1000A and the right gripper unit 1000B are arranged to face each other with a film sheet 1A placed between them, which is fed into the bag outer sealing part 300 to be sealed and formed into an intravenous fluid container 1.

The first gripper unit 1100 grips both sides of the film sheet and supplies it to the bag outer sealing part 300.

The first gripper unit 1100 may include a first rail 1110, a first base 1120, a first cylinder 1130, a first bracket 1140, and a pair of first jaws 1150.

The first rail 1110 is arranged along the x-direction in the drawing. The first base 1120 is slidably arranged on the first rail 1110. The first cylinder 1130 is coupled to the first base 1120. The first cylinder 1130 moves in the y-direction. The y-direction position of the first jaw 1150 may be adjusted by the first cylinder 1130.

The first bracket 1140 is connected to the first jaw 1150. The pair of first jaws 1150 may open and close by pneumatic pressure.

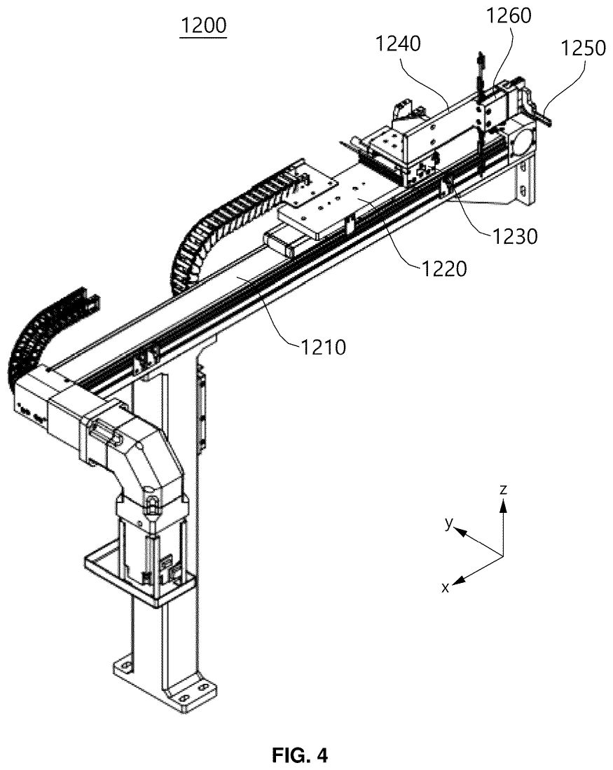

FIG. 4 is a diagram illustrating the second gripper unit 1200.

Referring to FIG. 4, the second gripper unit 1200 grips the side of the intravenous fluid container 1 opposite to the side where the hard port body 1a is located and supplies it to the hard port body sealing part 400.

The second gripper unit 1200 may include a second rail 1210, a second base 1220, a second cylinder 1230, a second bracket 1240, and a pair of second jaws 1250. The second rail 1210 is arranged along the x-direction. The second base 1220 is slidably arranged on the second rail 1210.

The second cylinder 1230 is coupled to the second base 1220. The second cylinder 1230 moves in the y-direction. The y-direction position of the second jaw 1250 may be adjusted by the second cylinder 1230.

The second bracket 1240 is connected to the gripper cylinder 1260. The pair of second jaws 1250 may open and close by means of the gripper cylinder 1260. The pair of second jaws 1250 substantially grips the intravenous fluid container.

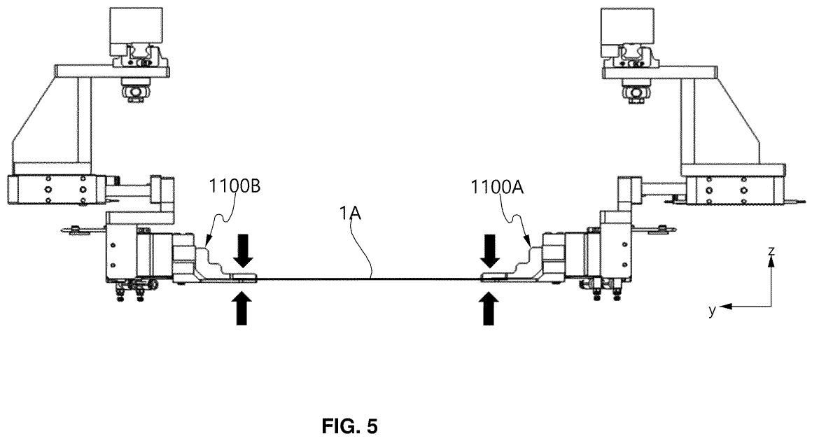

FIG. 5 is a diagram illustrating the intravenous fluid container 1 being gripped by the first gripper unit 1100.

Referring to FIG. 5, the left gripper unit 1100A grips one side of the film sheet 1A (which may be the first sheet F1 or the second sheet F2) that forms the intravenous fluid container 1, and the right gripper unit 1100B grips the other side of the film sheet 1A. Here, one side may be the side where the hard port body 1a of the intravenous fluid container is formed, and the other side may be the opposite side of where the hard port body 1a of the intravenous fluid container is formed. However, this may vary depending on the design of the intravenous fluid container manufacturing apparatus.

Since the first gripper unit 1100 (the left gripper unit 1100A and the right gripper unit 1100B) grips and pulls both sides of the film sheet 1A, the issue of the film sheet becoming misaligned, which occurs in conventional systems that pull only one side of the sheet, is improved.

FIGS. 6 to 9 are diagrams illustrating the operation process of the first gripper unit 1100 and the second gripper unit 1200.

Referring to FIGS. 6 to 9, the first gripper unit 1100 and the second gripper unit 1200 operate simultaneously. For example, four intravenous fluid containers 1 form one set, and a belt B for transporting the containers as a set is included. When the belt B transports the intravenous fluid containers 1 by one set, the first gripper unit 1100 and the second gripper unit 1200 simultaneously advance by a distance corresponding to one set in the transport direction of the intravenous fluid containers 1.

As shown in FIG. 6, the first gripper unit 1100 grips both sides of the film sheet 1A to be supplied to the bag outer sealing part 300. The second gripper unit 1200 grips the film sheet 1B of the foremost part (meaning the direction in which the intravenous fluid containers are transported) of a set of intravenous fluid containers, which have undergone outer sealing by an outer sealing mold (not shown) in the bag outer sealing part 300, at a first point P1. More specifically, the pair of second jaws 1250 of the second gripper unit 1200 grips a scrap SCR portion of the intravenous fluid container formed at the foremost part of the set of intravenous fluid containers.

A film sheet 1C shown in FIG. 6 indicates that the intravenous fluid container, which has undergone outer sealing in the bag outer sealing part 300, has been transported and is positioned at a second point P2.

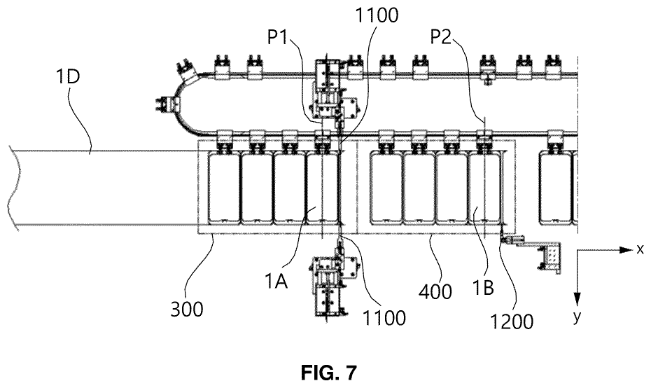

As shown in FIG. 7, the first gripper unit 1100 grips both sides of the film sheet 1A, moves it to the first point P1, and supplies it to the bag outer sealing part 300. Here, the first point P1 corresponds to the position of the intravenous fluid container 1A that is located at the most forward position, that is, the foremost position in the transport direction of a set of intravenous fluid containers 1 within the bag outer sealing part 300.

To explain in more detail, the first gripper unit 1100 grips the film sheet 1A at a predefined position before it is fed into the bag outer sealing part 300, and when the first gripper unit 1100 transports the film sheet 1A to the first point P1 of the bag outer sealing part 300, the outer sealing mold (not shown) of the bag outer sealing part 300 seals the outer edge of the film sheet 1A, thereby forming the outer contour of a set of intravenous fluid containers. The first point P1 is the position where the outer contour of the intravenous fluid container that is located at the foremost part in the transport direction (x-direction) of the film sheet (1A) among the outer contours of the set of intravenous fluid containers is formed.

The outer sealing mold (not shown) of the bag outer sealing part 300 is arranged above and below the dotted line indicated as 300 in FIG. 7, and descends from above and ascends from below, pressing the film sheet 1A to form the outer contour.

At this time, the second gripper unit 1200 transports the film sheet 1B, which has undergone outer sealing and was being gripped at the first point P1, to the second point P2.

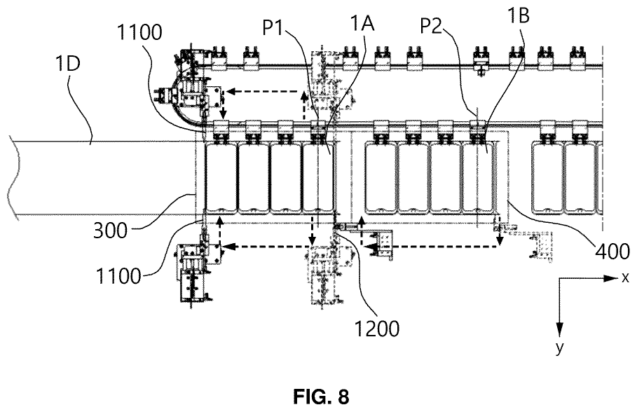

As shown in FIG. 8, when the upper and lower outer sealing molds (not shown) of the bag outer sealing part 300 press and secure the film sheet, the first gripper unit 1100 and the second gripper unit 1200 release their grip on the film sheet 1A, and then move outward to avoid colliding with the outer sealing molds (not shown). (Here, “outward” refers to movement away from the direction perpendicular to the direction in which the intravenous fluid containers are transported, as shown in FIG. 8.) The first gripper unit 1100 at the first point P1 and the second gripper unit 1200 at the second point P2 move rearward (i.e., opposite to the transport direction of the intravenous fluid containers) almost simultaneously, and then advance again toward the direction of the intravenous fluid containers to grip the film sheet.

That is, while the first gripper unit 1100 and the second gripper unit 1200 are moving rearward, the outer sealing mold of the bag outer sealing part 300 presses the film sheet, and outer sealing of the intravenous fluid container proceeds. The second gripper unit 1200 then moves to the first point P1 and grips the film sheet 1A located at the first point P1, where sealing is in progress.

Then, the first gripper unit 1100 grips a new film sheet 1D to be supplied to the bag outer sealing part 300.

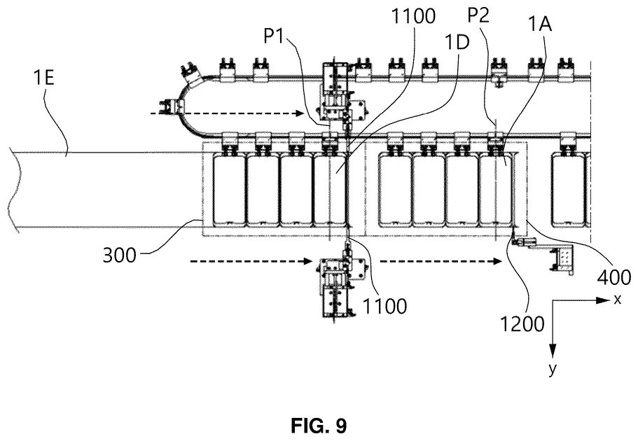

As shown in FIG. 9, when the outer sealing of the intravenous fluid container is completed in the bag outer sealing part 300 and the outer sealing molds (not shown) of the bag outer sealing part 300 open, the first gripper unit 1100 and the second gripper unit 1200 simultaneously advance to the first point P1 and the second point P2, respectively.

The first gripper unit 1100 grips a new set of intravenous fluid containers 1D and moves to the first point P1. The second gripper unit 1200 grips the intravenous fluid container 1A, which has completed outer sealing in the bag outer sealing part 300, and moves to the second point P2. Here, the second point P2 corresponds to the position of the intravenous fluid container 1A that is located at the most forward position, that is, the foremost position in the transport direction of a set of intravenous fluid containers 1 within the hard port body sealing part 400.

The above-described process is repeated, and the intravenous fluid containers 1 are transported.

In this way, while sealing is being performed in the bag outer sealing part 300, the second gripper unit 1200 moves in advance to the first point P1, grips the outer scrap SCR of the portion where the outer contour of the intravenous fluid container has been formed, and, once outer sealing is completed in the bag outer sealing part 300, the second gripper unit 1200 moves by one pitch (the distance by which one set of intravenous fluid containers is transported) and transports the film sheet (one set of intravenous fluid containers) to the second point P2.

As such, in the present invention, the process of the vacuum suction pad entering the interior of the outer sealing mold and gripping the film sheet only after the outer sealing mold (not shown) of the bag outer sealing part opens, which is required in conventional methods, is eliminated, resulting in a significant increase in the production speed of the intravenous fluid containers.

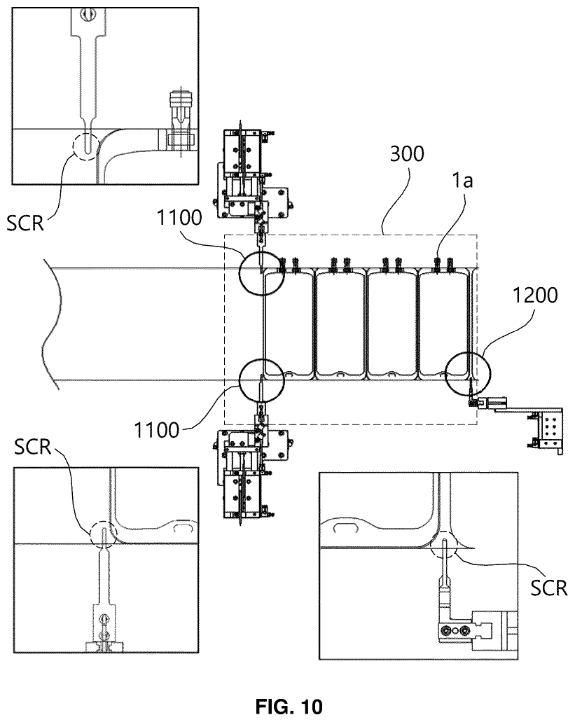

FIG. 10 is a diagram illustrating the grip positions of the first gripper unit and the second gripper unit.

Referring to FIG. 10, the first gripper unit 1100 and the second gripper unit 1200 each grip the scrap SCR portion that is discarded after the outer sealing and forming of the intravenous fluid container, and move. In the conventional method, when a film sheet softened due to heat is gripped and transported using a vacuum pad, deformation may occur at the suction site. However, in the present invention, in order to prevent such problems, the gripping positions of the first gripper unit 1100 and the second gripper unit 1200 are not on the body of the intravenous fluid container but on the scrap SCR portion located between the bodies.

As described above, the intravenous fluid container manufacturing apparatus according to one preferred embodiment of the present invention has been described in detail with reference to the accompanying drawings.

It should be understood that the above-described embodiments of the present invention are provided only as examples in all aspects and are not limited. The scope of the present invention is defined according to the appended claims rather than the above detailed description. Additionally, the meaning and scope of the appended claims as well as all the modifications and modified forms that are drawn from the meaning and scope of the appended claims should be interpreted as being included in the scope of the present invention.

### INDUSTRIAL APPLICABILITY

The present invention can be efficiently applied in the field of manufacturing intravenous fluid containers.

What is claimed is:

1. An intravenous fluid container manufacturing apparatus comprising:
a conveyance unit for conveying an intravenous fluid container,
wherein the conveyance unit comprises:
a first gripper unit configured to supply the intravenous fluid container to a bag outer sealing part; and
a second gripper unit configured to supply the intravenous fluid container to a hard port body sealing part,
when an outer sealing mold of the bag outer sealing part contacts the intravenous fluid container, the second gripper unit enters the bag outer sealing part and grips an edge of the intravenous fluid container at a first point, and
when the outer sealing mold of the bag outer sealing part is separated from the intravenous fluid container, the second gripper unit, together with the first gripper unit of the bag outer sealing part, conveys the intravenous fluid container to the hard port body until a second point is reached while holding the edge of the intravenous fluid container.

2. The intravenous fluid container manufacturing apparatus of claim 1, wherein the second gripper unit moves from an outlet of the bag outer sealing part to an outlet of the hard port body sealing part.

3. The intravenous fluid container manufacturing apparatus of claim 1, wherein the first gripper unit and the second gripper unit move together simultaneously.

4. The intravenous fluid container manufacturing apparatus of claim 3, wherein a plurality of intravenous fluid containers form one set, and a belt is included for transporting the intravenous fluid containers as a set,
wherein when the belt transports one set of the intravenous fluid containers, the first gripper unit and the second gripper unit simultaneously move by a distance corresponding to one set.

5. The intravenous fluid container manufacturing apparatus of claim 1, wherein, when the outer sealing mold of the bag outer sealing part comes into contact with the intravenous fluid container, the first gripper unit moves backward from the first point and the second gripper unit moves to the first point and grips the intravenous fluid container.

6. The intravenous fluid container manufacturing apparatus of claim 1, wherein the first point corresponds to a position of the intravenous fluid container that is located at the foremost position among a set of intravenous fluid containers in the bag outer sealing part.

7. The intravenous fluid container manufacturing apparatus of claim 6, wherein the second point corresponds to a position of the intravenous fluid container that is located at the foremost position among the set of intravenous fluid containers in the hard port body sealing part.

8. The intravenous fluid container manufacturing apparatus of claim 1, wherein the first gripper unit includes a left gripper unit and a right gripper unit, and the left gripper unit and the right gripper unit are arranged to face each other.

9. The intravenous fluid container manufacturing apparatus of claim 8, wherein the left gripper unit grips one side of the intravenous fluid container, and the right gripper unit grips the other side of the intravenous fluid container, thereby supplying the intravenous fluid container to the bag outer sealing part.

10. The intravenous fluid container manufacturing apparatus of claim 1, wherein the first gripper unit and the second gripper unit each grab a scrap of the intravenous fluid container and move.
